(19) United States
(12) Patent Application Publication
(10) Pub. No.: US 2014/0375539 A1
(43) Pub. Date: Dec. 25, 2014

(54) Method and Apparatus for a Virtual Keyboard Plane

(71) Applicant: Thaddeus Gabara, Murray Hill, NJ (US)

(72) Inventor: Thaddeus John Gabara, Murray Hill, NJ (US)

(21) Appl. No.: 13/922,165

(22) Filed: Jun. 19, 2013

(51) Int. Cl. G06F 3/03

(52) U.S. Cl. CPC G06F 3/0304
USPC 345/156

(57) ABSTRACT

Two cameras forming a 3-D camera system are used to project the key pattern of the plane from the displayed keyboard of a small display of a smartphone to that of a larger initialization plane of a virtual keyboard which is displaced in a parallel plane and increased in size from the displayed keyboard plane. The displayed keyboard is located on a screen of the display screen of the smartphone. The angular variation of the finger's position from the displayed keyboard plane based on the camera image indicates the keyboard character being depressed. Plenoptic cameras can also be used. The displacement distance or baseline of the plenoptic cameras is advantageous to increase. Highlighting the keys on the displayed keyboard when the fingers are in the initialization plane or activation plane of a virtual keyboard either by color, shading, or any other visual means provides positive feedback to the user.

### BACKGROUND OF THE INVENTION

Portable wireless systems (cellphones, smartphones, etc.) are offering the user with easy access to others users via multimedia, text, voice, images or videos. Similarly, the wireless systems interconnect to the Internet to store these components on a server. The camera on these wireless systems have been employed to store and/or send multimedia, photos and video for postings on the web, sharing with other users, or for personal perusal for a later date.

The keyboard on the smartphone has very small buttons. To enter data, the size of the buttons causes errors in character capture due to the large size of the fingers and the small size of the buttons on the display screen. This aggravates the user and causes the user to correction the entry. This can be time consuming and slows down the process of data entry into the smartphone or portable wireless system.

Some portable wireless systems provide a camera that captures still pictures or video (movies). Some wireless phones offer only one camera per wireless system typically located on the opposite side of the display screen. A camera can be as simple as a pinhole and image sensor or the pinhole can be replaced with a main lens. However, as the cost of the camera decreases, a second camera has been placed on the same side as the display screen. These two cameras are typically on the reverse sides of the portable wireless system where the user can switch between the capture of images or video on either side of the potable wireless system.

Plenoptic cameras offer an ability to take a picture of a setting and refocus the image of the setting to different plane of depth (POD) using the original Light Field Photograph (LFP) image. A plenoptic camera comprises a microlenses array and at least one image sensor array. Each microlens captures all the light in its field of view (FOV) that arrives along the rays entering that particular microlens. The microlenses array may be microlens placed in an array of 4×4, 6×6, 20×20, etc. Since each microlens is displaced from another in the array, each microlens captures all the light of a slightly different FOV or different viewpoint. Thus, the light striking one region of the microlenses array is different than the light striking another region of the microlenses array. Since the light information captured by the image sensor array due to a plurality of microlenses can be stored in memory, a computer algorithm can be developed to manipulate the light information retrieved from memory to generate how the image would appear when viewed from a different viewpoint. These different viewpoints can provide images having different POD while still using the original LFP image. The microlenses can be located between a main lens and the image sensor array. Several known software tools based on the computer algorithm, hereinafter called “embedded algorithm”, can manipulate the original LFP image to focus at various PODs of the LFP visual field.

### BRIEF SUMMARY OF THE INVENTION

Smart phones usually have at least one camera. The inventive technique is to place at least one plenoptic camera on the smart phone and use the embedded algorithm to adjust the POD of a LFP image. The image taken by the plenoptic camera contains all the information for different PODs to be displayed. This embedded algorithm manipulates the original LFP image via a user to alter the POD. The image taken by the plenoptic camera contains all the information for different PODs of the LFP visual filed to be determined by using the embedded algorithm.

A preferred embodiment of the invention is the apparatus comprising two cameras placed on the same side of a portable wireless system offering the measurement of the physical displacement of objects. The accuracy of the measurement increases as the distance between the two cameras increases forming a larger baseline. One possible location where the two cameras can be placed on a smartphone is surrounding the display screen. The image sensor in the camera can be manufactured in CMOS or CCD.

Another preferred embodiment of the invention is the apparatus comprising two cameras forming a 3-D camera system used to project the key pattern of the plane from the displayed keyboard of a small display of a smartphone to that of a larger initialization plane of a virtual keyboard which is displaced in a parallel plane and increased in size from the displayed keyboard plane. The displayed keyboard is located on a screen of the display screen of the smartphone (wireless portable unit). The angular variation of the finger's position from the displayed keyboard plane indicates the keyboard character being depressed. As the count of the cameras increase more than two, the accuracy of finger placement improves since there is more data available to determine the location of the fingertip.

Another preferred embodiment of the invention is the apparatus comprising two plenoptic cameras placed on the same side of a portable wireless system offering the capture of a 3-D picture or video which can be re-focused to different objects at various parallel planes or Planes of Depth (POD). The displacement distance or baseline of the plenoptic cameras is advantageous to increase. One example is when it is equal to the average distance of between a user's eyes. The accuracy of finger placement improves since the additional cameras provide additional data.

Another preferred embodiment is highlighting the keys on the displayed keyboard when the fingers are in the initialization plane or activation plane of a virtual keyboard. As the user depresses the key in the initialization plane of a virtual keyboard, the corresponding key on the display is identified either by color, shading, or any other visual means. The identification on the displayed keyboard of the highlighted keys being depressed in the initialization plane of a virtual keyboard provides positive feedback to the user that their fingers are in the proper position and over the correct keys in the initialization plane of a virtual keyboard.

Another preferred embodiment is a keyboard apparatus comprising: a plurality of cameras located on a same surface of a wireless potable unit as a display screen; a displayed keyboard located on a screen of the display screen; a virtual keyboard located parallel and above the displayed keyboard on the screen; the virtual keyboard has dimensions proportionally larger than the displayed keyboard; and a finger estimating system to identify locations of fingertips relative to the virtual keyboard using images obtained from the cameras, further comprising: an initialization plane of the virtual keyboard having a first working distance: and an activation plane of the virtual keyboard having a second working distance, further comprising: a projection of the elevation angle and the azimuth angle of the location of fingertips onto the initialization or the activation plane determines points on an x-y Cartesian coordinate plane, further comprising: an embedded algorithm to identify a Plane of depth (POD) of fingertips relative to the virtual keyboard using Light Field Photograph (LFP) images of the cameras, wherein at least one camera has one or more lens, further comprising: an elevation angle and a tilt altitude angle determined from at least two camera images calculates the location of fingertips based on the finger estimating system to determine if the location of fingertips are in the initialization or the activation plane. The apparatus, further comprising: a mapping system translating the points on the x-y Cartesian coordinate plane into corresponding keys of the virtual keyboard, further comprising: keys highlighted on the displayed keyboard a first way if location of fingertips are in the initialization plane and keys highlighted on the displayed keyboard a different way if location of fingertips are in the activation plane, further comprising: a text box in the screen of the display screen displaying a sequence of keys corresponding to a corresponding sequence of the fingertips entering the activation plane.

Another preferred embodiment is a keyboard apparatus comprising: a plurality of plenoptic cameras located on a same surface of a wireless potable unit as a display screen; a displayed keyboard located on a screen of the display screen; a virtual keyboard located parallel and above the displayed keyboard on the screen; the virtual keyboard has dimensions proportionally larger than the displayed keyboard; an embedded algorithm to identify a Plane of depth (POD) of location of fingertips relative to the virtual keyboard using a Light Field Photograph (LFP) image obtained from the cameras; and a finger estimating system to identify the locations of fingertips in an x-y Cartesian coordinate plane, further comprising: an initialization plane of the virtual keyboard having a first working distance: and an activation plane of the virtual keyboard having a second working distance, further comprising: the embedded algorithm determines if location of fingertips are located in the initialization or the activation plane, further comprising: a projection of an elevation angle and an azimuth angle of the location of fingertips onto the initialization or the activation plane determines points on the x-y Cartesian coordinate plane, further comprising: a mapping system translating the points on the x-y Cartesian coordinate plane into corresponding keys of the virtual keyboard, further comprising: keys highlighted on the displayed keyboard a first way if location of fingertips are in the initialization plane and keys highlighted on the displayed keyboard a different way if location of fingertips are in the activation plane, further comprising: a text box in the screen of the display screen displaying a sequence of keys corresponding to a corresponding sequence of the fingertips entering the activation plane.

Another preferred embodiment is a method of using a virtual keyboard comprising the steps of: placing a plurality of cameras beside a display screen of a wireless portable unit; a number of baselines based on the plurality of cameras; evaluating angles of elevation and altitude for each fingertip in an obtained image from each camera; calculating a height of each fingertip from the display screen based on the angles using the finger estimation system; a sequence of fingertips that are depressed; mapping the sequence of fingertips to a sequence of keys and printing characters corresponding to the sequence of keys in a text box of the display screen, further comprising the steps of: projecting the elevation angle and the azimuth angle of fingertips onto an initialization or an activation plane to determine points on an x-y Cartesian coordinate plane, further comprising the steps of: highlighting keys of the displayed keyboard based on if the location of fingertips are located in the initialization or the activation plane, wherein a text box in the screen of the display screen displaying a sequence of keys corresponding to a corresponding sequence of the fingertips entering the activation plane, wherein the mapping sequence translates the points on the x-y Cartesian coordinate plane into corresponding keys of the virtual keyboard.

### BRIEF DESCRIPTION OF THE DRAWINGS

Please note that the drawings shown in this specification may not necessarily be drawn to scale and the relative dimensions of various elements in the diagrams are depicted schematically. The inventions presented here may be embodied in many different forms and should not be construed as limited to the embodiments set forth herein. Rather, these embodiments are provided so that this disclosure will be thorough and complete, and will fully convey the scope of the invention to those skilled in the art. In other instances, well-known structures and functions have not been shown or described in detail to avoid unnecessarily obscuring the description of the embodiment of the invention. Like numbers refer to like elements in the diagrams.

FIG. 1 shows the characters of a keyboard that are associated with the fingers of a user.

FIG. 2A illustrates a left side view of the keyboard with the user's hand against the face of the keyboard.

FIG. 2B depicts the top view of the keyboard with the user's hands in a starting position.

FIG. 2C shows bottom side view of the keyboard with the user's hands against the face of the keyboard.

FIG. 3 shows the user's fingers located in the initialization plane of a virtual keyboard plane using this inventive technique.

FIG. 4A depicts a perspective view of the virtual and conventional keyboard using this inventive technique.

FIG. 4B illustrates a perspective view of the virtual and modified keyboard using this inventive technique.

FIG. 4C shows a perspective view of the virtual and second modified keyboard using this inventive technique.

FIG. 5A depicts the fingers in the initialization plane of the virtual keyboard plane and two elevation angles at the ends of the baseline in accordance with this inventive technique.

FIG. 5B shows one finger in the depressed plane while the remaining fingers are in the initialization plane located of the virtual keyboard plane and two elevation angles at the ends of the baseline in accordance with this inventive technique.

FIG. 5C shows two elevation angles at the ends of the baseline assuming all fingers are in the depressed plane illustrating this inventive technique.

FIG. 5D depicts the two angles at the ends of the baseline in greater detail in accordance with the present invention.

FIG. 5E shows the side view of FIG. 5D illustrating this inventive technique.

FIG. 5F illustrates the top view of FIG. 5E in accordance with the present invention.

FIG. 6 shows the tabulated results of FIG. 5A and FIG. 5C in accordance with the present invention.

FIG. 7 depicts a perspective view of the virtual and second modified keyboard with four cameras in accordance with this inventive technique.

FIG. 8A shows all the baselines for three cameras in accordance with the present invention.

FIG. 8B illustrates some of the baselines for four cameras in accordance with this inventive technique.

FIG. 8C depicts the remaining baselines for fours cameras in accordance with the inventive technique.

FIG. 9 shows a flowchart of placing hands in the correct position on the virtual plane of the keyboard in accordance with this inventive technique.

FIG. 10A-C shows a flowchart of initializing of the individual fingers in the correct position on the virtual plane of the keyboard in accordance with this inventive technique.

FIG. 11 depicts a flowchart of placing fingers in the correct position on the virtual plane of the keyboard in accordance with the present invention.

FIG. 12 shows a flowchart for detecting and printing characters based on depressed fingers in accordance with the present invention.

FIG. 13A depicts a system representation a smart phone with two cameras in accordance with the present invention.

FIG. 13B illustrates an expanded view of each of the cameras with a separate imaging chip (CMOS or CCD) for each lens and in accordance with the present invention.

FIG. 14A depicts a smart phone with two plenoptic cameras in accordance with the present invention.

FIG. 14B shows a block diagram of the smart phone with two plenoptic cameras in accordance with the present invention.

FIG. 15 illustrates the smart phone with the angular variation at the two plenoptic cameras in accordance with the present invention.

### DETAILED DESCRIPTION OF THE INVENTION

Smart phones usually have at least one camera. The inventive technique is to place two cameras on the same side of the smart phone as far apart from each other to increase the baseline. The baseline is the distance separating one observation point from another. The increased baseline provides a more accurate depth perception. The processor uses the obtained images from both cameras to determine the positions of objects parallel displaced from the surface of the smart phone. Additional cameras can be placed on the same side to improve the accuracy in depth perception. For example, plenoptic camera can improve the accuracy since they introduce additional camera lens into the apparatus. The depth perception can be used determine the positions of fingers, for instance. Thus, an initialization plane of a virtual keyboard plane can be formed above the surface of the smart phone representing a scaled version of the displayed keyboard presented on the display screen.

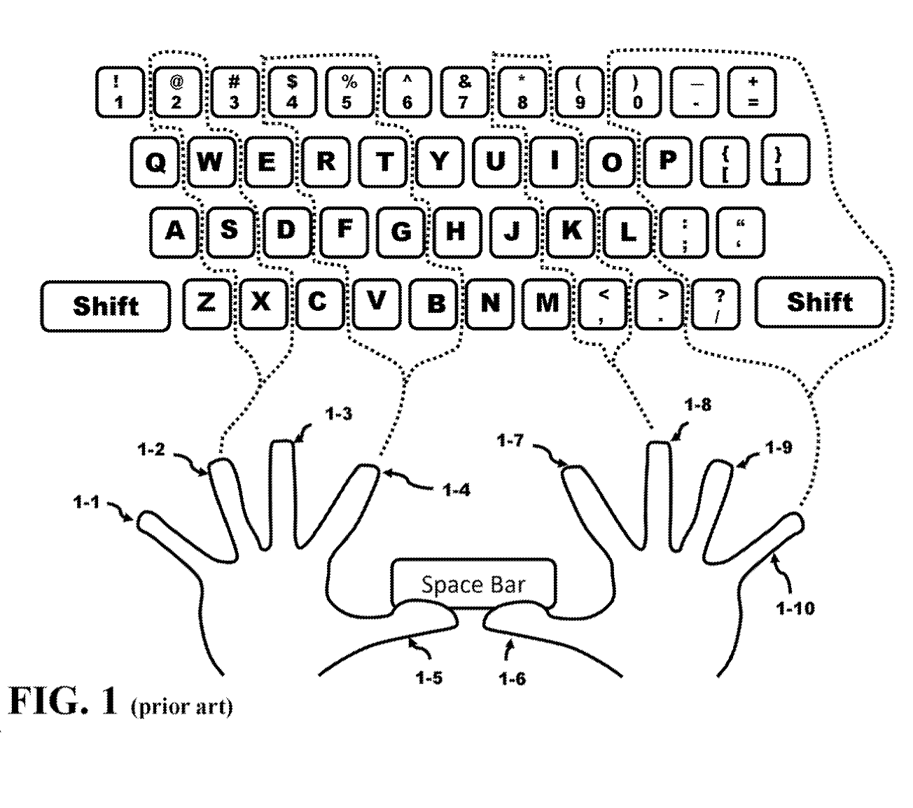

FIG. 1 illustrates a right and left hand and identified fingers with partitions to how these identified fingers are applied to keys of a conventional keyboard. The dotted lines from the top of the ring finger 1-2, the index finger 1-4, the middle finger 1-8, and the right pinky 1-10 enclose those keys on the keyboard which are typically used by the corresponding fingers. The pinky 1-1 on the left-hand is used to depress 1. Q, A, Shift, and Z. The ring finger 1-2 on the left-hand is used to depress 2, W, S, and X. The middle finger 1-3 on the left-hand is used to depress 3, E, D, and C. The index finger 1-4 on the left-hand is used to depress 4, 5, R, T, F, G, V, and B. The thumb 1-5 on the left-hand is used to depress the Spacebar. The thumb 1-6 on the right-hand is used to depress the Spacebar. The index finger 1-7 on the right-hand is used to depress the 6, 7, Y, U, H, J, N, and M. The middle finger 1-8 on the right-hand is used to depress the 8, I, K, and <. The ring finger 1-9 on the right-hand is used to depress the 9, O, L, and >. The right pinky 1-10 can depress the corresponding enclosed keys in the dotted enclosure.

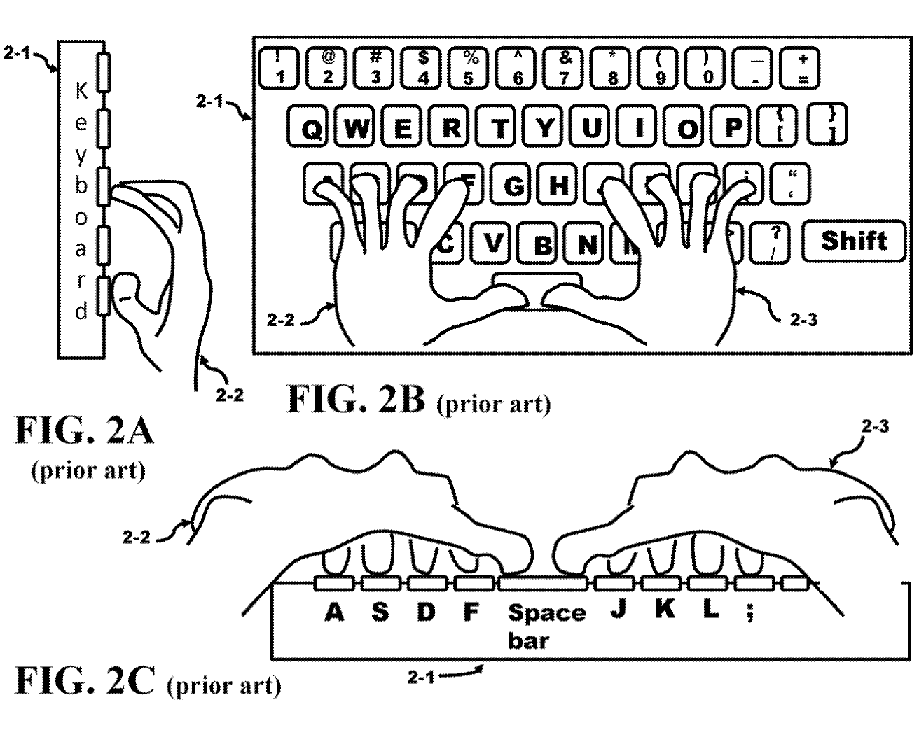

FIG. 2A illustrates a left side view of the keyboard 2-1 and the left hand 2-2 with this tips of the fingers touching the displayed keyboard 2-1. FIG. 2B illustrates the keyboard 2-1 from a top view with the hands 2-2 and 2-3 positioned on the keys corresponding to the initial starting point well known in the art. The fingers of the left-hand 2-2 are on the keys A, S, D and F with the thumb on the Spacebar. The fingers of the right-hand 2-3 are on the keys J, K, L, and ;. This is typically the starting position a typist positions their fingers before they start typing. The typist is comfortable in placing their fingertips at all the corresponding positions of keys on the displayed keyboard without looking. FIG. 2C illustrates a bottom side view of the left-hand 2-2 and the right-hand 2-3 on the keyboard 2-1. Again the fingers of the left-hand 2-2 are on the initial positions of the keys A, S, D, F and Spacebar. The fingers of the right-hand 2-3 are on the keys Spacebar, J, K, L, and ;. This displayed keyboard is scaled down to fit on the display screen of the smart phone. Once on the display screen, the keyboard is again physical since a user can touch the keys and generate text messages, words, sentences. etc. The difficulty is that the buttons on the keyboard of the display screen are too small for the fingertips of most users. For some users, this makes data entry a discomfort.

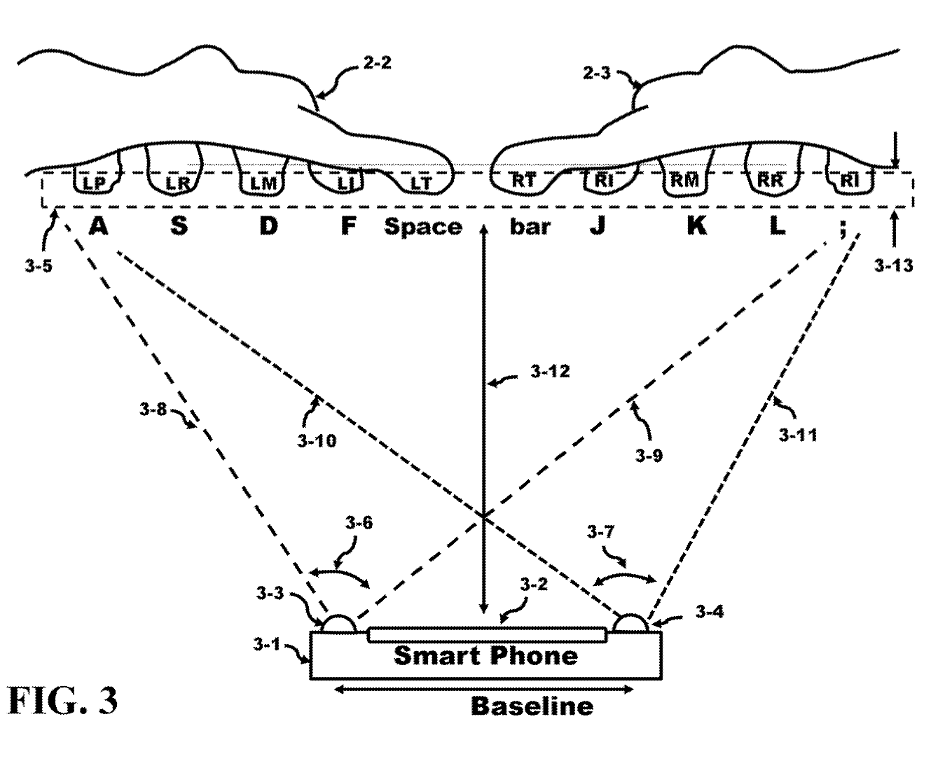

The smart phone 3-1 with an inventive initialization plane of a virtual keyboard plane 3-5 is illustrated in FIG. 3. A side view of the smart phone or the cross-section view of the smart phone, along with the initialization plane of a virtual keyboard plane 3-5 is presented. The smart phone 3-1 contains a display screen 3-2. In addition, a camera 3-3 is shown on the left side, and a camera 3-4 is shown to the right side of the display screen 3-2. These two cameras visually pick up obtained images from objects within its field of view. The camera 3-3 sees within its field of view (FOV) 3-6 comprising the fingers of the users left-hand 2-2 and right-hand 2-3. Shown are the fingertips LP (Left Pinky), LR (Left Ring), LM (Left Middle), LI (Left Index), LT (Left Thumb), RT (Right Thumb), RI (Right Index), RM (right Middle), RR (Right Ring), and RP (Right Pinky). The FOV 3-6 is bounded by the boundary lines 3-8 and 3-9. The camera 3-4 sees within its FOV 3-7 comprising the fingers of the users left-hand 2-2 and right-hand 2-3. The FOV 3-7 is bounded by the boundary lines 3-10 and 3-11. The user places his left hand 2-2 and right-hand 2-3 into the approximate position of an initialization plane of a virtual keyboard plane that is located a distance 3-12 from the display screen. The fingers of the hands are at the starting position of the keyboard mentioned earlier as A, S, D, and F for the left-hand 2-2 and J, K, L, and ; for the right-hand 2-3. The virtual keyboard 3-5 has an approximate working distance 3-13 that the user's fingers can be placed. These fingers still register as being in the virtual keyboard plane 3-5 which is called the initialization plane. The initialization plane of a virtual keyboard plane is a scaled replica of the displayed keyboard being presented on the display screen 3-2 where the scale has been magnified alleviating the small button-large finger problem mentioned earlier. The larger scaled virtual keyboard plane 3-5 allows the user to easily enter data into the smart phone 3-1.

The locations of the fingers are determined internally on the smart phone by the visual data being captured by the camera 3-3 and the camera 3-4. The cameras 3-3 and 3-4 are separated from one another by the baseline. The baseline increases by positioning the cameras further apart from one another and allows a more accurate determination of where the fingers are located or positioned in the initialization plane of a virtual keyboard plane 3-5 in FIG. 3. On this smart phone 3-1, the camera 3-3 and the camera 3-4 are separated from one another as much as possible. The data from these two cameras are applied or coupled to the finger estimation system on board the smart phone 3-1. The finger estimation system comprises a microprocessor, memory, video stream from the cameras (where the video stream itself or selected images of the video stream may be used), comparison analysis software, etc., that analyzes the location of the same corresponding finger in both images. These obtained images can be captured at time intervals which occur frequent enough to let the software in the finger estimation system to determine the location of the fingertips while minimizing power dissipation. Based on the angular difference of the same finger in the image of field of view of the two cameras 3-3 and 3-4, the finger estimation system can estimate the perpendicular distance from the plane of the display screen 3-2 of where the finger currently exists in relation to a plane that is co-planar with the plane of the screen display. For instance, the fingertips are located at the distance 3-12. Examples of determining these measurements will be given shortly.

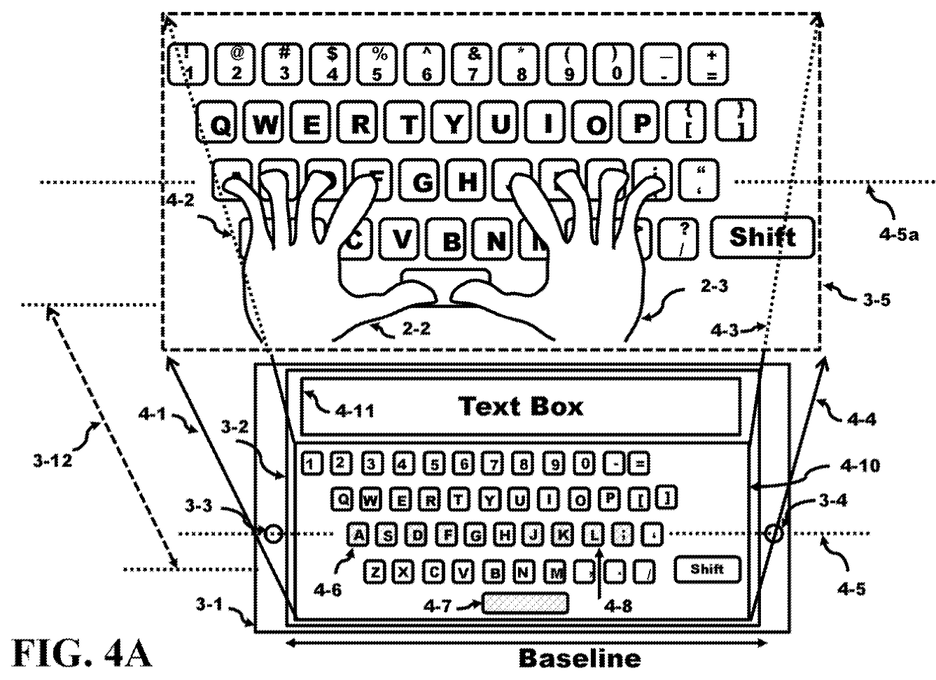

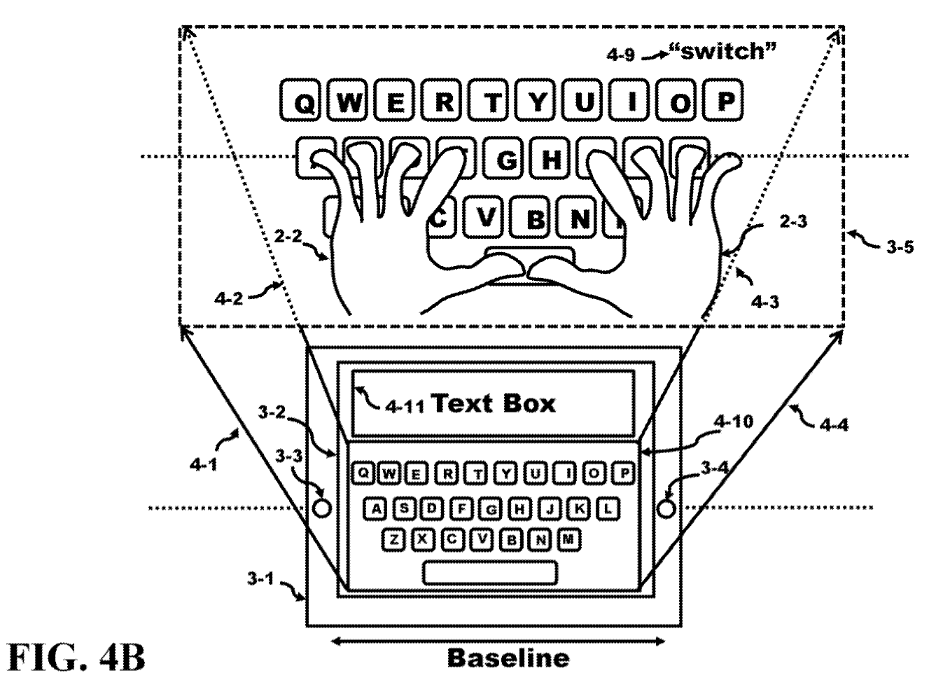

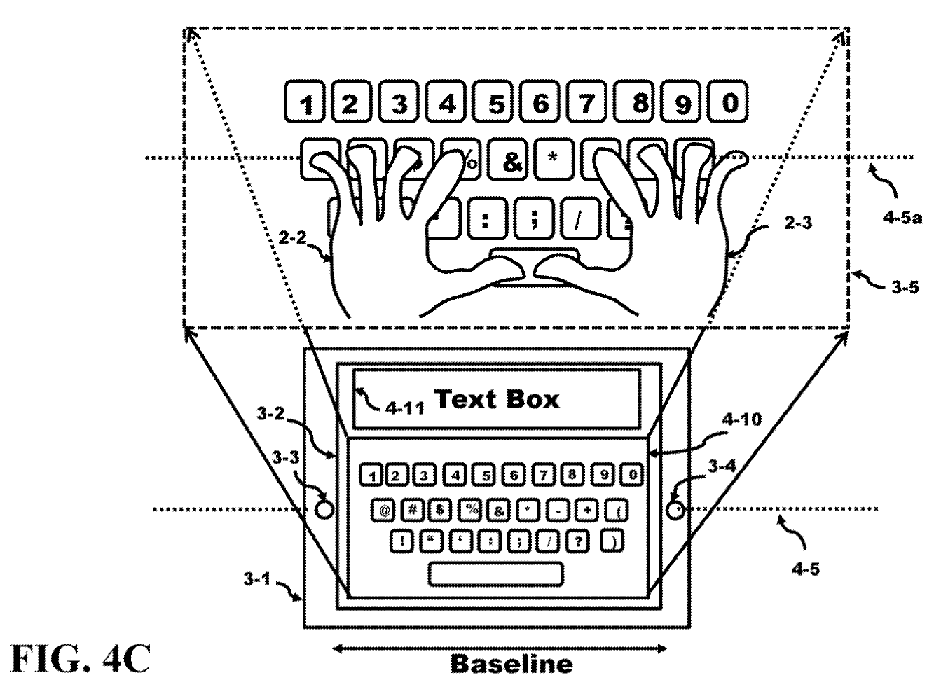

FIG. 4A illustrates a perspective view of the smart phone 3-1, the display screen 3-2, the displayed keyboard plane 4-10, and the virtual keyboard plane 3-5. The image of the displayed keyboard plane 4-10 and the virtual keyboard plane 3-5 are separated by the distance 3-12. The left camera 3-3 and the right camera 3-4 are separated from one another by the baseline. The projection of the displayed keyboard plane 4-10 to the virtual keyboard plane 3-5 is along the lines 4-1, 4-2, 4-3, and 4-4, respectively. The hands 2-2 and 2-3 are placed at the initial starting point of the keys as is well known by the average typist on the initialization plane of a projected virtual keyboard plane 3-5. As the user types, the text is entered into the textbox 4-11 on the display screen 3-2.

The dotted line 4-5 aligned with the cameras 3-3 and 3-4 and the dotted line 4-5a are in a plane and perpendicularly intercept the virtual plane 3-5 along the second row of keys in the initialization plane of a virtual keyboard 3-5. This is the location where the fingertips are easiest to detect. This provides a single degree of freedom along the line 4-5a. However, as the fingertips are moved towards the ‘Q’ or ‘Z’ row, the determination of the position of the fingertips becomes more difficult since there are now two degrees of displacement in a single degree of freedom.

A second inventive idea is for the finger estimating system to provide feedback to the user to ensure that the user is pressing the correct virtual keys on the initialization plane of a virtual keyboard plane of 3-5. The way this method is performed is that as the finger estimating system determines the position of the fingers the corresponding keys on the display screen are highlighted providing feedback to the user to ensure that; a) his fingertips are over the correct keys; and b) his fingertips are over the right keys in the initialization plane 3-5. As the finger estimating system measures the location of the fingers in the initialization plane of the virtual keypad and provides feedback to the user by highlighting those keys on the displayed keyboard of the smart phone 3-1 allowing the user better controllability in typing their message. The positive feedback provided to the user by shading or coloring (highlighting) the keys is shown in the physical display screen 4-10 when the fingertips of the user are superimposed over particular letters in the initialization plane of a virtual keyboard plane 3-5. The fingertips are over A, S, D, F, Spacebar, J, K, L and ;. The corresponding keys on the display screen 3-2 are shaded, for example, A 4-6, Spacebar 4-7 and L 4-8 are identified. This positive feedback to the user helps keep the user's fingertips at the desired location. Furthermore, as the user presses down on the key into an activation plane to activate the character, the key in the display screen can change to a different color, emit an audio signal, emit the audio of the character being depressed, or any combination.

The first form of highlighting is the initial position of the fingers which presents one particular shade given to the key, for example, see 4-6, 4-7 and 4-8. As the key is depressed and registers, then the key may change into a different color or a different shade indicating to the user that a key that was depressed has been registered in the system (also being displayed in the text box 4-11) and the user can move the fingers position back into the initialization plane. Thus, there are two forms of feedback that the user experiences. The first is that the keys are shaded (highlighted a first way) when the fingers are in the initialization plane of a virtual keyboard plane 3-5. The second is that the keys in the displayed keyboard 4-10 can change colors or acquire a different shade shaded (highlighted a second way) when the fingertips are in the activation plane.

FIG. 4B illustrates the smart phone 3-1 with a limited display of keys. This is usually done on a display screen 3-2 of the smart phone 3-1 so that a subset of all the individual keys can take up more room making the keys in the displayed keyboard more accessible for the individual to use their fingers on the display screen to type out messages.

The inventive process described here uses the cameras 3-3 and 3-4 on the smart phone 3-1 and allow the projection of this displayed keyboard 4-10 into a virtual keyboard 3-5. The dotted line 4-5 aligned with the cameras 3-3 and 3-4 and the dotted line 4-5a are in a plane and perpendicularly intercept the virtual plane 3-5 along the second row of keys in the virtual keyboard 3-5. The projection scales the displayed keyboard 4-10 into a larger dimension allowing with greater ease for the user to place his fingers of hands 2-2 and 2-3 on this virtual limited keyboard 3-5. The projection of the displayed keyboard plane 4-10 to the virtual keyboard plane 3-5 is along the lines 4-1, 4-2, 4-3, and 4-4, respectively. By verbally stating “switch” 4-9, the second part of the limited keys of the keyboard is illustrated in FIG. 4C. These special characters are illustrated on the displayed keyboard 4-10 located on a display screen 3-2 of the smart phone 3-1. The inventive process described here uses the cameras 3-3 and 3-4 on the smart phone 3-1 and allow the projection of this displayed keyboard 4-10 into a virtual keyboard 3-5. The projection scales the displayed keyboard 4-10 into a larger dimension allowing with greater ease for the user to place his fingers of hands 2-2 and 2-3 on this virtual limited keyboard 3-5.

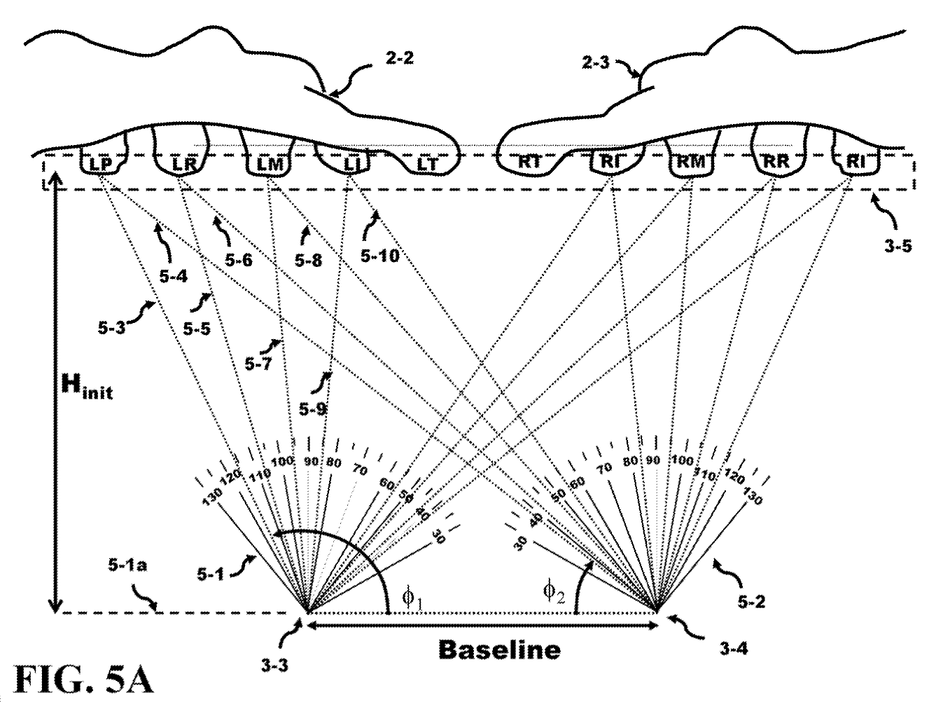

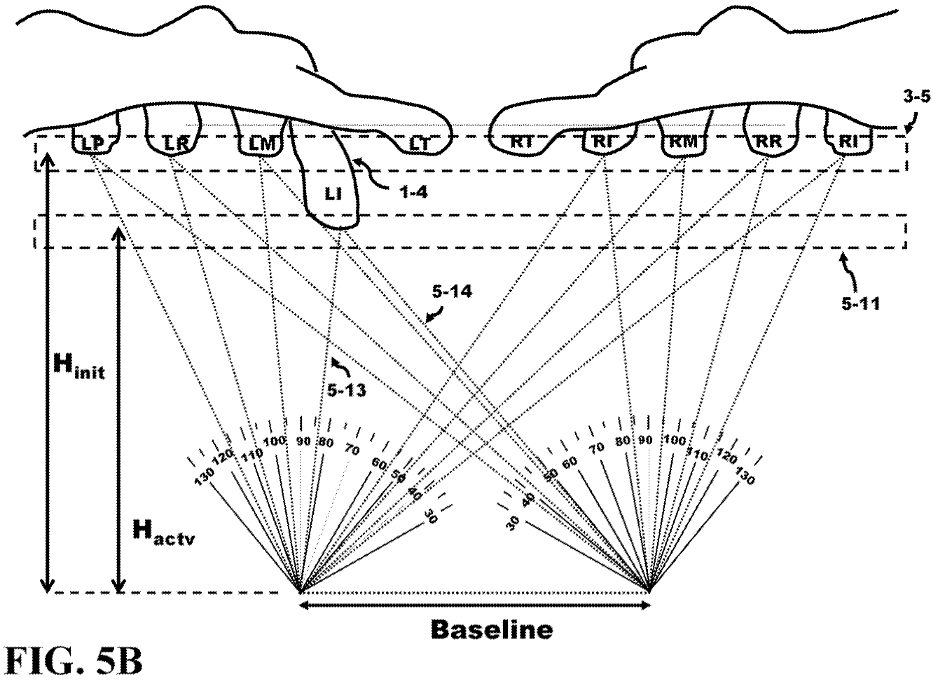

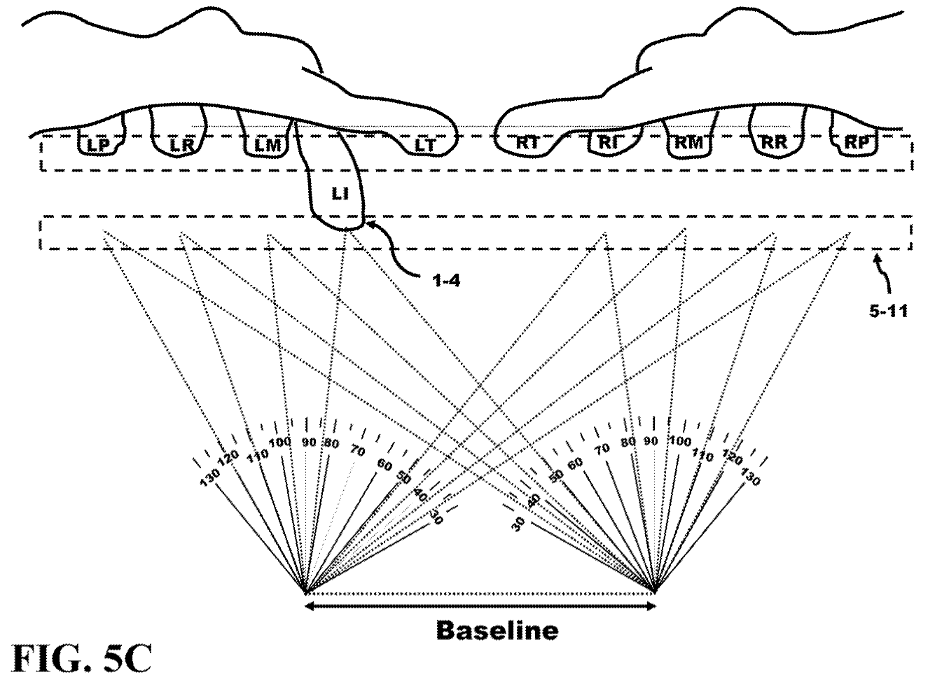

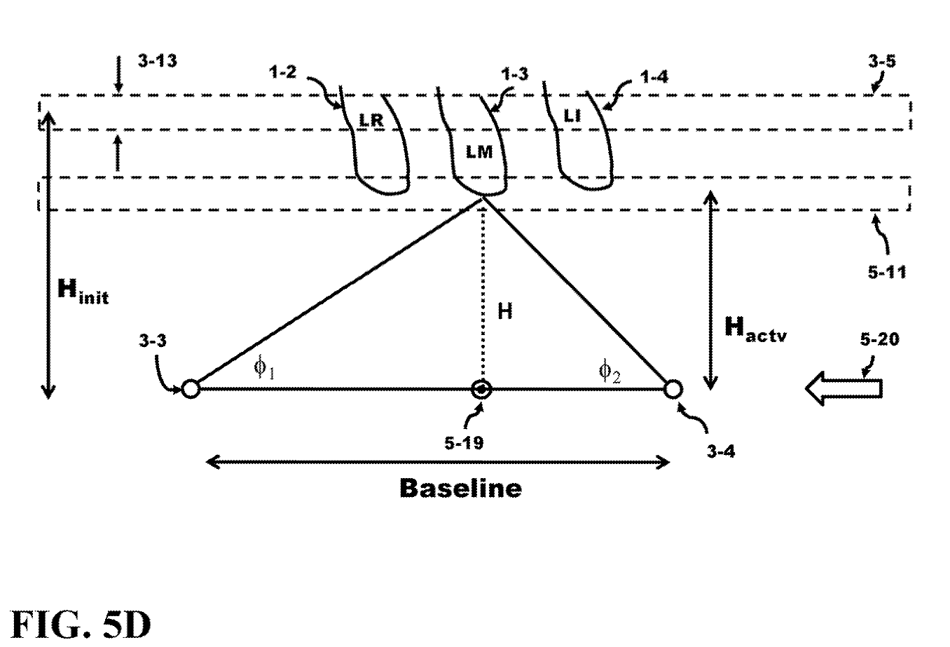

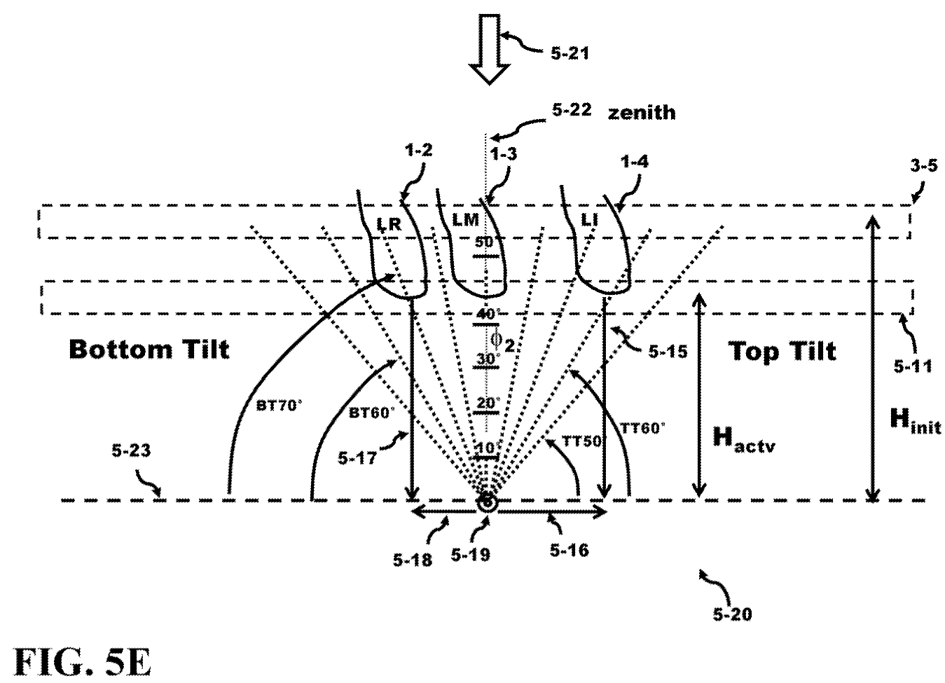

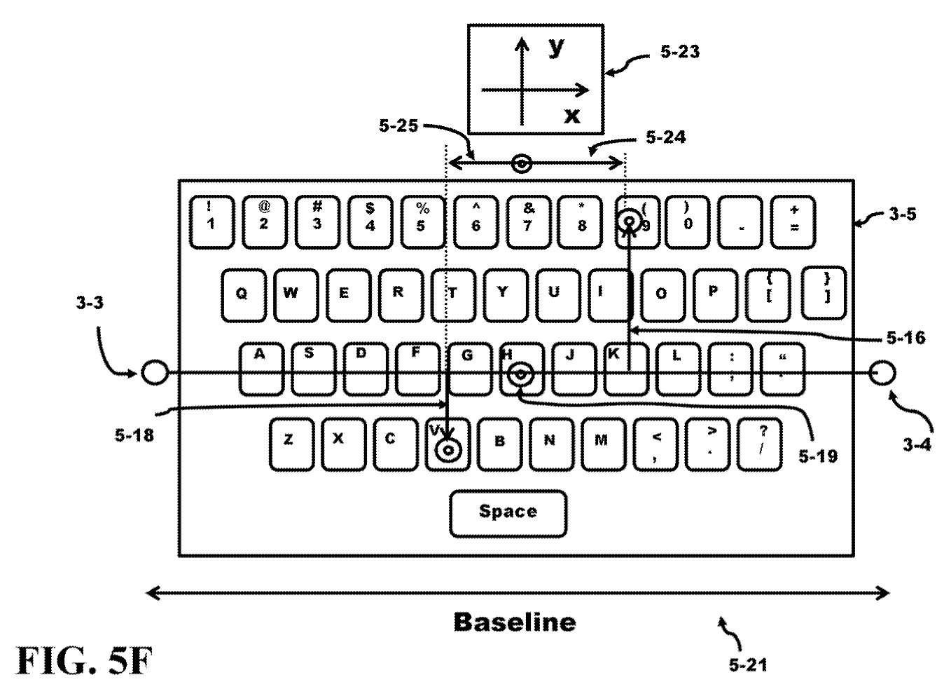

FIG. 5A illustrates the fingers in an initialization plane of the virtual keyboard plane 3-5. As these fingers are within the initialization plane of the virtual keyboard 3-5, the cameras 3-3 and 3-4 (not shown) at the ends of the baseline can be used to measure the approximate angle of the left pinky (LP), the left ring finger, the left middle finger, left index the left on the left hand 2-2. On the right-hand 2-3, the initialization plane of a virtual keyboard plane 3-5 can contain the right thumb, the right index finger, the right middle finger, the right ring finger, and the ring right index finger. All of these fingers are displaced from one another within the initialization plane of the virtual keyboard plane 3-5. Because of their displacement and the baseline distance between the two cameras, each of the cameras intercepts different rays for the left pinky of the left-hand 2-2. In other words, the left camera 3-3 has ray 5-3 to the left pinky while the right camera located at 3-4 as the ray 5-4 where they intersect at the left pinky of the left-hand 2-2. The finger estimating system is used again to determine the approximate angles. The angular difference based on the separation of the cameras in the plane of the display screen 5-1a and the large baseline distance, the height Hᵢₙᵢₜ, can be calculated between the initialization plane of the virtual keyboard plane 3-5 and the plane of the display screen to 5-1a. The left ring finger (LR) on the hand 2-2 has the rays 5-5 and 5-6 respectively. The left middle finger (LM) on the hand 2-2 has the rays 5-7 and 5-8. The left index finger (LI) has the rays 5-9 and 5-10. There are similar rays for the right-hand 2-3 for the right index finger, right middle thing there, right ring finger, and the right index finger. The protractors 5-1 and 5-2 associated with the finger estimating system can be used to estimate the angle of each ray. Each of the rays for the right hand has not been labeled but the finger estimating system can be used to estimate the angle of each ray.

In FIG. 5B the left index finger 1-4 is depressed into the activation plane 5-11 and the rays for it are shown as 5-13 and 5-14. These rays are in contrast to the rays 5-9 and 5-10 in FIG. 5A where the left index finger is in initialization plane of a virtual keyboard plane 3-5. Thus, the difference between these two sets of angles can be used to determine the height Hᵢₙᵢₜ of the virtual keyboard plane 3-5 and the height H_{actv} of the activation plane 5-11. As mentioned earlier, the keys in the initialization plane of a virtual keyboard plane 3-5 have a shading of some type, while the keys in the activation plane would have a different shading or color to indicate to the user that these keys are being depressed and entered into the database for the smart phone 3-1.

In FIG. 5C all of the rays are placed on the activation plane 5-11. This is as if all of the fingers of the left and right hand are in the activation plane 5-11, similar to the finger 1-4. Another factor of the inventive aspect is the sequence of when these fingers entered the activation plane. This order will give us the proper sequence of the keys or letters associated with the keys providing the words that we are interested in producing for the various sentences or for that a sequence of letters to produce words. So the finger active estimating system not only determines the position of the fingers but also determines the sequence of when the fingertips enter the activation plane 5-11 such that the sequence of keys generates meaningful data (form words) that could be used at a later date. In other words, the sequence of fingertips being detected entering the activation plane 5-11 is LR over the letter “s”, LM over the letter “e”, LI over the letter “t”, Space, LI over the letter “b”, RI over the letter “u”, LI over the letter “t”, L over the letter “t”, RR over the letter “o”, RI over the letter “n”, to form the words “set button” based on a conventional keyboard (see FIG. 1).

In FIG. 5D, the cameras 3-3 and 3-4 are positioned at the end of the baseline, the activation plane 5-11, the virtual keyboard plane 3-5, and the altitude angles for the left middle finger 1-3 in are illustrated. Measured from the left camera 3-4 the finger is at φ₁ while measured from the camera 3-4 the fingers is at φ₂. Using the EQU. 1, the value of H can be determined. These two angles and the baseline are sufficient to determine the height H which will be equivalent to the activation height H_{actv} (see EQU. 1). Assume T=90°. The value of H can be either Hᵢₙᵢₜ or H_{actv}, where there is a +/− variation equal to approximate working distance 3-13 divided by two. The fingertip LM 1-3 projects onto a point 5-19. This point is translated into an equivalent point in the virtual keyboard using a Cartesian coordinate system. The two angles for the LR 1-2 and LI 1-4 are not illustrated to minimize the complexity of the figure. The view from the perspective of the arrow 5-20 is presented next.

FIG. 5E illustrates the view from the perspective of the arrow 5-20 in FIG. 5D. The initialization plane 3-S of the virtual keyboard and the activation plane 5-11 are illustrated. The fingertip LM 1-3 projects onto point 5-19 which is on the baseline. The baseline is currently perpendicular to the plane of the image given in FIG. 5E. The elevation 5-22 of the fingertip LM 1-3 is at an angle about 45°. The elevation angle of the fingertip LR 1-2 and the fingertip LI 1-4 are each about 45°. Note that these fingers are in the activation plane 5-11.

The height Hᵢₙᵢₜ can be determined by the finger estimating system from the angles of the rays intercepting the fingertip of the initialization plane of a virtual keyboard plane by EQU. 1 as:

$$H ( {H}_{init} or {H}_{actv} ) = ( baseline ) \frac{( \frac{tan {ϕ}_{1} tan {ϕ}_{2}}{tan {ϕ}_{1} + tan {ϕ}_{2}} )}{sin T} \qquad ( EQU . 1 )$$

Where H is the height of the triangle (either H_{actv} or Hᵢₙᵢₜ), φ1 is the elevation angle of ray 5-3, φ₂ is the elevation angle of ray 5-4, T is the tilt altitude angle measured perpendicular to the baseline from the displayed keyboard plane, and baseline is the distance between the two cameras 3-3 and 3-4. The top tilt altitude angle is measured from the top half of the displayed keyboard plane while bottom tilt altitude angle is measured from the bottom half of the displayed keyboard plane.

The top Tilt altitude angle is the angle from the plane of the keyboard display towards the zenith, for example, TT60° and TT50°. The bottom Tilt altitude angle is the angle from the plane of the keyboard towards the zenith, for example, BT70° and BT60°. The Tilt altitude angle for fingertip LM 1-3 is about 90° since the zenith line 5-22 has a Tilt altitude angle of 90°. The fingertip LI 1-4 has a top Tilt altitude angle of about TT60° of 60° and the fingertip LR 1-2 has a bottom Tilt altitude angle of about BT70° of 70°.

A perpendicular line is projected from each finger onto a point of the translated activation keyboard plane 5-23 which lies co-planar with the physical keyboard plane 3-5. A Cartesian coordinate plane can be traced onto the translated activation keyboard plane 5-23. Fingertip LR 1-2 projects the line 5-17 unto the Cartesian coordinate plane, fingertip LM 1-3 projects a line along the zenith line 5-22 unto the Cartesian coordinate plane, and fingertip LI 1-4 projects the line 5-15 unto the Cartesian coordinate plane. The identification of the intersection of the projected perpendicular line intersects the Cartesian coordinate plane 5-23 to identify an x and y value for the point. For example, point 5-19 has a y of 0, dropped line 5-15 has a y of 5-16, and dropped line 5-17 has a −y of 5-18. The x value is illustrated in the view from the arrow 5-21 in the next figure.

Turing to FIG. 5F, the view 5-21 is presented to present the x value. The Cartesian coordinate plane is superimposed over the translated activation keyboard plane 5-23 which happens to be co-planer with the virtual keyboard 3-5. The (0,0) of the Cartesian coordinate plane is aligned over the letter H (0,0), although different alignments are possible, which is the approximate midpoint of the baseline between the cameras 3-3 and 3-4.

A mapping system translates the projected points of the x-y Cartesian coordinate plane 5-23 into corresponding keys of the initialization plane of a virtual keyboard. For example, the fingertip LR 1-2 has a −y of 5-18 and a −x of 5-25 which identifies the letter V. The fingertip LM 1-3 has a y of 5-19 (0) and an x of (0) which identifies the letter H. The fingertip LI 1-4 has a +y of 5-16 and a +x of 5-24 which identifies the number 9.

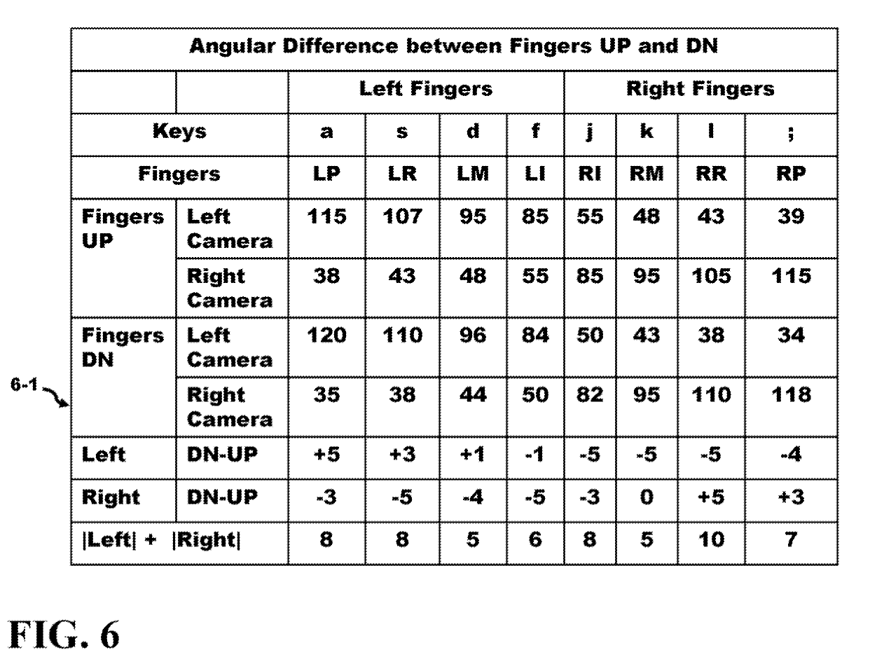

FIG. 6 illustrates the tabular measurements 6-1 of the angular difference between the fingers being in the UP and DN positions. Assume T=90°. The UP position is when the finger is in plane 3-5 and the DN position is when the finger is in the activation plane 5-11. The two rightmost columns correspond to the ‘Left Fingers’ and ‘Right Fingers’. The row ‘Keys’ show an example of the left fingers of the left hand on the letters a, s, d, and f and the right fingers of the right hand on the letters j, k, I, and ;. This is known as the starting position and to further qualify this, the next row ‘Fingers’ provides the particular finger placed on the letter in the above row. These are the left pinky (LP), the left ring finger (LR), the left middle finger (LM), the left index finger (LI). Then it's the right index finger (RI), right middle finger (RM), right ring finger (RR), and the right pinky (RP). The next two rows labeled ‘Finger UP’ and ‘Finger DN’ describe the conditions when the fingers are up and the fingers are down from the perspective of the left and right cameras. In other words, for the ‘Finger UP’ row where all the fingers are UP in the initialization plane of a virtual keyboard plane 3-5, the left camera measures the angles of the fingertips at 115°, 107°, 95°, 85°, 55°, 48°, 43°, and 39°, from left FP to RP, respectively. Still, when all the fingers are UP, the right camera measures the angles 38°, 43°, 48°, 55°, 85° 950°, 105°, and 115°. In other words, when all the fingers are UP, the left camera measures the angles 115°, 107°, 95°, 85°, 55°, 48°, 43°, and 39°, from left FP to RP, respectively. Still, for the ‘Finger DN’ row where all the fingers are DN in the activation plane 5-11, the left camera measures the angles 120°, 110°, 96°, 84°, 50° 43°, 38°, and 34° from left FP to RP, respectively, while the right camera measures the angles 35°, 38°, 44°, 50°, 82°, 95°, 110°, and 118′, from left FP to RP, respectively. The next row ‘Left’ provides the difference measured at the left camera between the DN-UP angles. The next row ‘Right’ provides the difference measured at the right camera between the DN-UP angles. The last row measures the total difference in degrees for these measurements. These values indicate that the extraction of the fingertips in the initialization plane of a virtual keyboard plane and the activation planes can be distinguished.

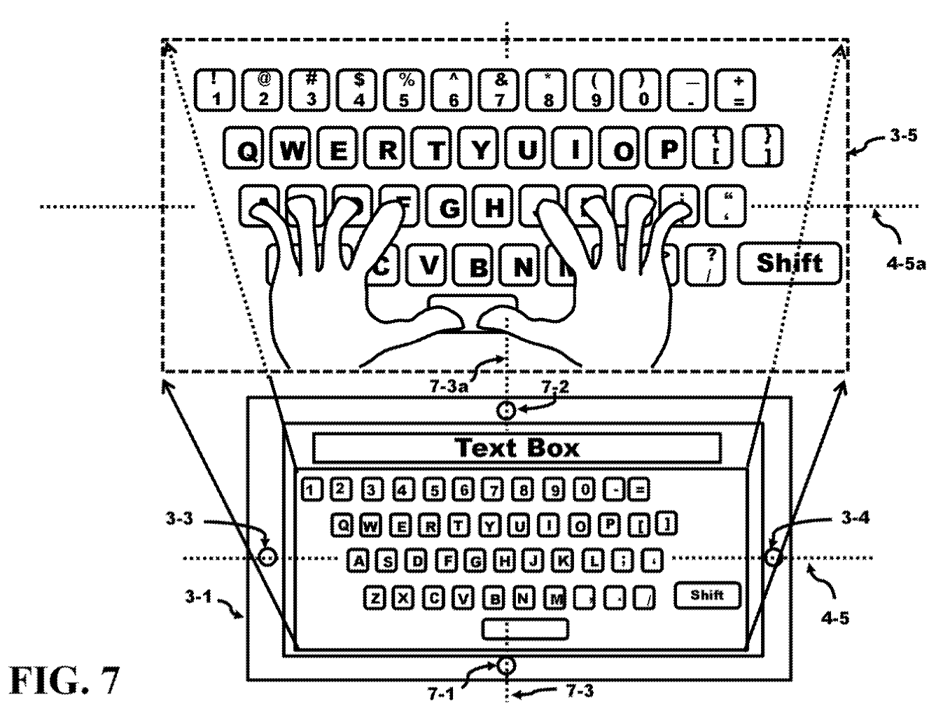

In FIG. 7, additional cameras 7-1 and 7-2 are introduced on the top and bottom of the smart phone 3-1. The camera on the bottom 7-1 and the camera on the top 7-2 provide more data in determining the actual position of the fingertips in the initialization plane of a virtual keyboard plane 3-5. As mentioned earlier, the plane containing 4-5, 4-5a, and the cameras 3-3 and 3-4 is perpendicular to the virtual keyboard plane 3-5. And the intersection of this plane with the virtual keyboard plane 3-5 provides one degree of freedom to determine the displacement of the fingertips along the virtual line 4-5a. With the additional cameras 7-1 and 7-2, the line 7-3 and 7-3a perpendicularly intersect the virtual keyboard plane 3-5 offer another degree freedom line along the line 7-3a to provide at least a second degree of freedom to determine the displacement of the fingertips along the virtual line 7-3a. With at least two degrees of freedom, the ability to determine and distinguish the position of the fingertips from the initialization plane of a virtual keyboard plane 3-5 towards the activation plane becomes more accurate.

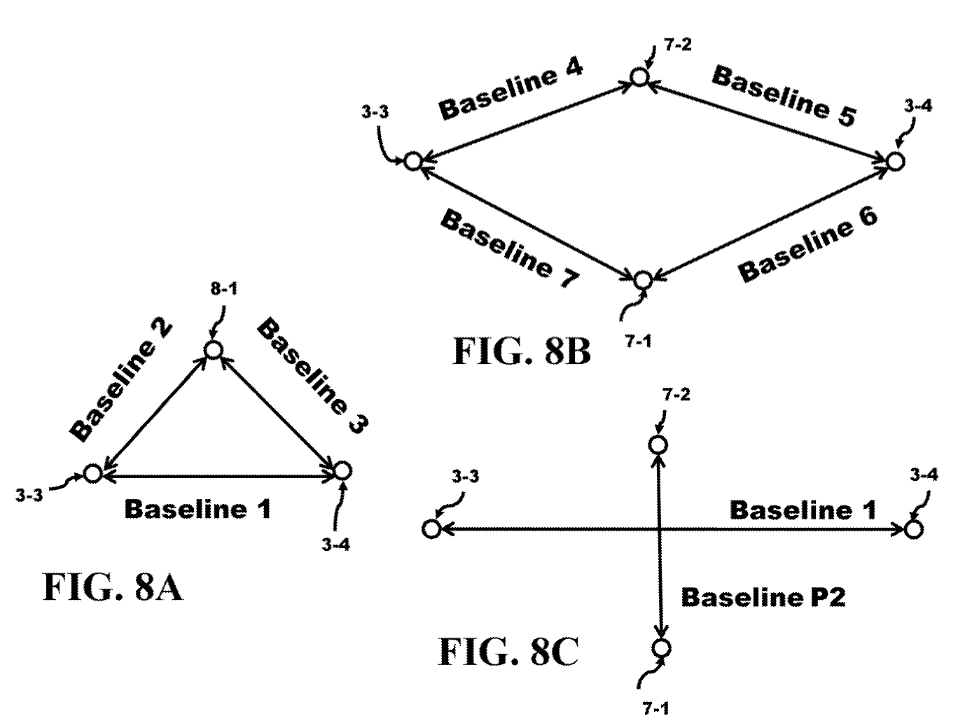

FIG. 8A, FIG. 8B, and FIG. 8C illustrate the degrees of freedom available as the camera count exceeds two. In FIG. 8A, the addition of the camera 8-1 provides three baselines to determine the fingertips physical position. The original baseline between cameras 3-3 and 3-4 is called the baseline 1. In addition, baseline 2 exists between cameras 3-3 and 8-1. The last baseline between camera 8-1 and 3-4 is baseline 3.

In FIG. 8B and FIG. 8C illustrates the number of baselines for four cameras. FIG. 8B illustrates the baselines along the periphery of the four camera pattern. The four cameras are 3-3, 3-4, 7-1, and 7-2. The first baseline exist between cameras 3-3 and 7-2 and is called baseline 4. The next baseline is between cameras 7-2 and 3-4 and is called baseline 5, the third baseline is between cameras 3-4 and 7-1 and is called baseline 6. The next baseline is between cameras 7-1 and camera 3-3 and is called baseline 7. In addition, as illustrated in FIG. 8C, there are perpendicular baselines between 3-3 and 3-4 called baseline 1 and between cameras 7-1 and 7-2 called baseline P2. These baselines offer several degrees of freedom to determine the fingertip position in a four camera system.

The three camera system has three baselines while the former camera system has six baselines. As the baseline count increases, the finger estimating system has more data to provide a more accurate positioning of the fingertips in the initialization plane of a virtual keyboard plane and the activation plane. Thus, the three camera system is preferred over the two camera system and the four camera system is preferred over the three camera system. All of these cameras can be replaced with plenoptic cameras to offer even greater accuracy in determining the position of the fingertips.

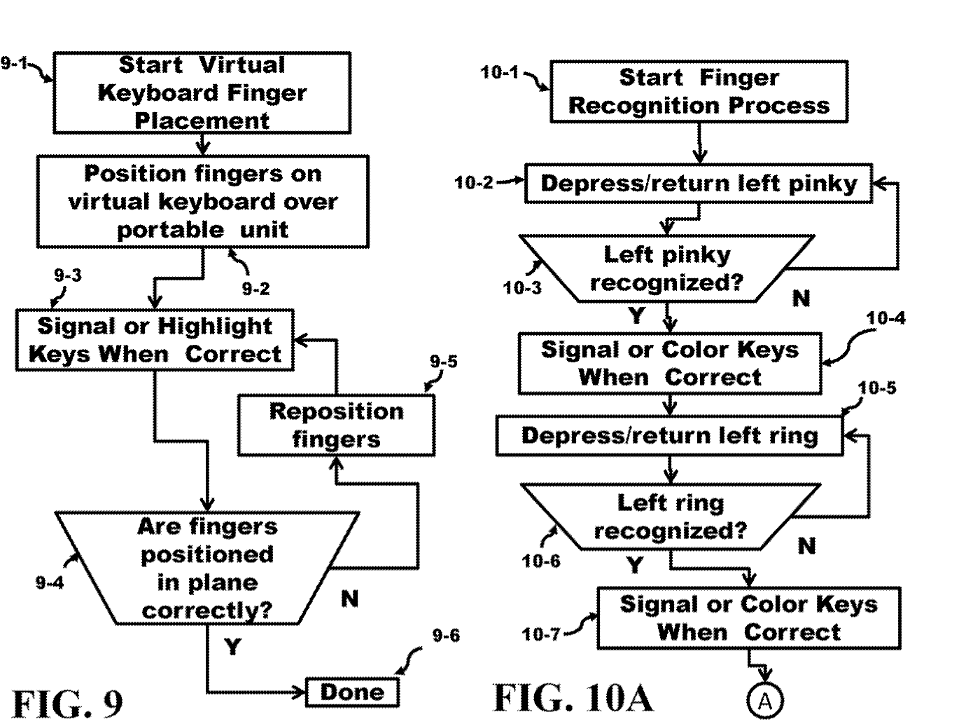

FIG. 9 illustrates the virtual keyboard finger placement process. The start virtual keyboard finger placement process 9-1 moves to position fingers in the initialization plane of a virtual keyboard plane over the portable unit 9-2. If your fingertips are in the correct position, then either emit an audio signal or highlight the keys (with a shade, color or distinction means) on the display screen 9-3 of the smart phone when the fingers are in the plane 3-5. If they're not position correctly 9-4 then reposition the fingers 9-5 until a signal or a highlighting key occurs 9-3. When all fingers are positioned in the plane correctly 9-4 move to done 9-6.

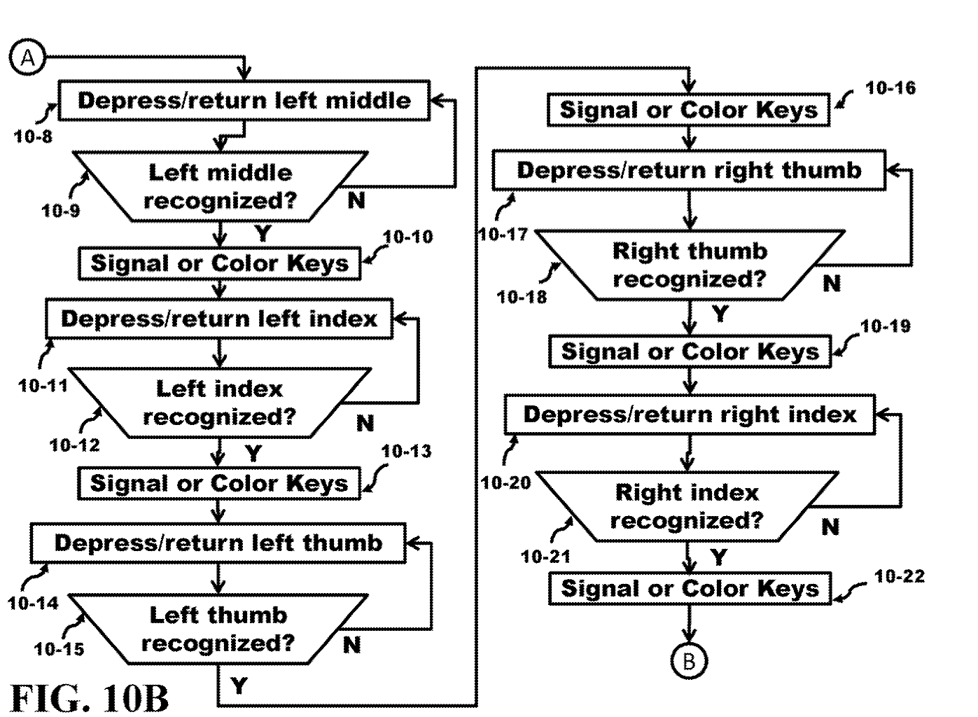

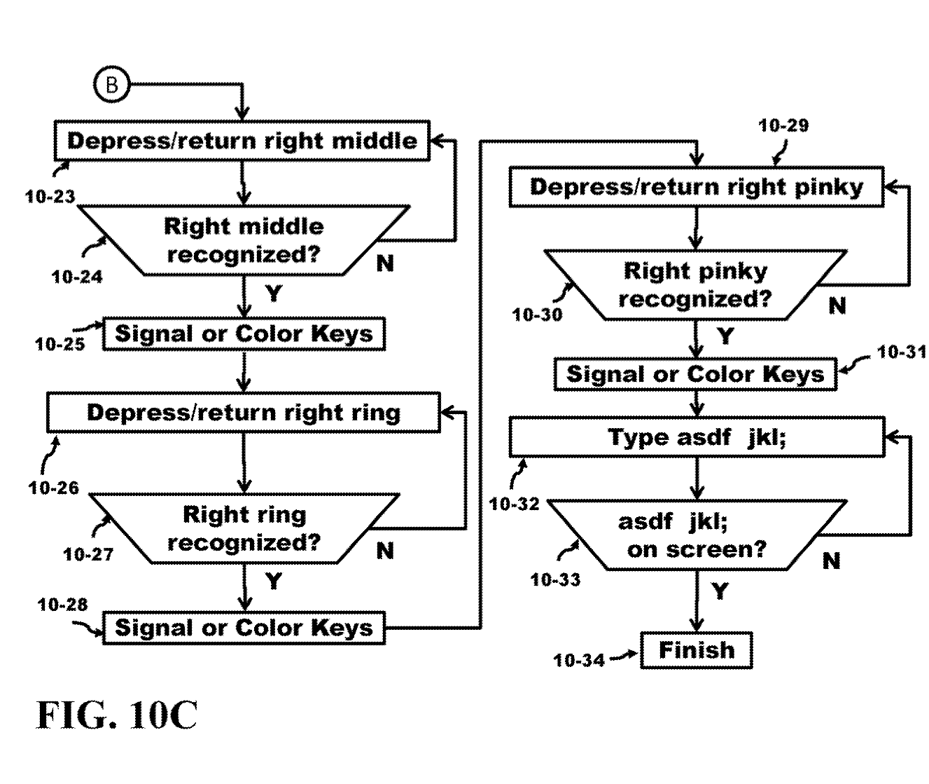

FIG. 10A illustrates the start finger recognition process 10-1 after the fingers are positioned correctly in the initialization plane of a virtual keyboard plane. A sequence of steps can be used to determine the proper movement of the fingertips to move from the initialization plane of a virtual keyboard plane playing to the activation plane. This can occur by displacing each of the fingertips in sequence and observing or listening to an affirmation signal, view a shaded key, or color that key fingertip has reached the activation plane. First, the left pinky is depressed and return 10-2, if the left pinky is recognized 10-3 move on to emitting a signal or color the keys 10-4 that are displayed on a display screen with the pinky correctly enters into the activation later otherwise depress the left pinky again. Next, depress the left ring finger 10-5 to see if it's recognized 10-6. If not, repeat the process, otherwise, signal or color the keys 10-7 on the display screen. Then, press the left middle finger 10-8 and if recognized 10-9 signal or color the keys on the display screen 10-10. Otherwise moved back to block 10-8. See if the left index is recognized 10-12, and if so, signal or color to keys 10-13 or redo the process 10-11 until the left index finger is recognized 10-12. Then, press the left thumb 10-14 until it's recognized 10-15 and signal or color the keys on the display screen 10-16, accordingly. Next, the right thumb of the right hand is pressed and held 10-17 until it's recognized 10-18 and signal or color the keys on the display screen 10-19. The process flow remains the same for the remaining fingers, depress the right index finger 10-20 until the right index finger is recognized 10-21 and signal or color the keys corresponding to the right index 10-22 on a display screen for the user to see. Then, do the right middle finger 10-23 until the right middle finger is recognized 10-24 and signal or color the keys on the keyboard 10-25. Do the right ring finger 10-26 until the right ring finger is recognized 10-27 and color the corresponding key on the display screen or signal a sound audibly 10-28. Do the right pinky 10-29 until the right pinky is recognized 10-30 and signal the corresponding keys or color them 10-31. Then test typing with the left and right fingers AES DF JKL; 10-32. If it shows on that the display screen 10-33, finish 10-34. Otherwise, return to typing 10-32 on till the display screen shows the corresponding characters.

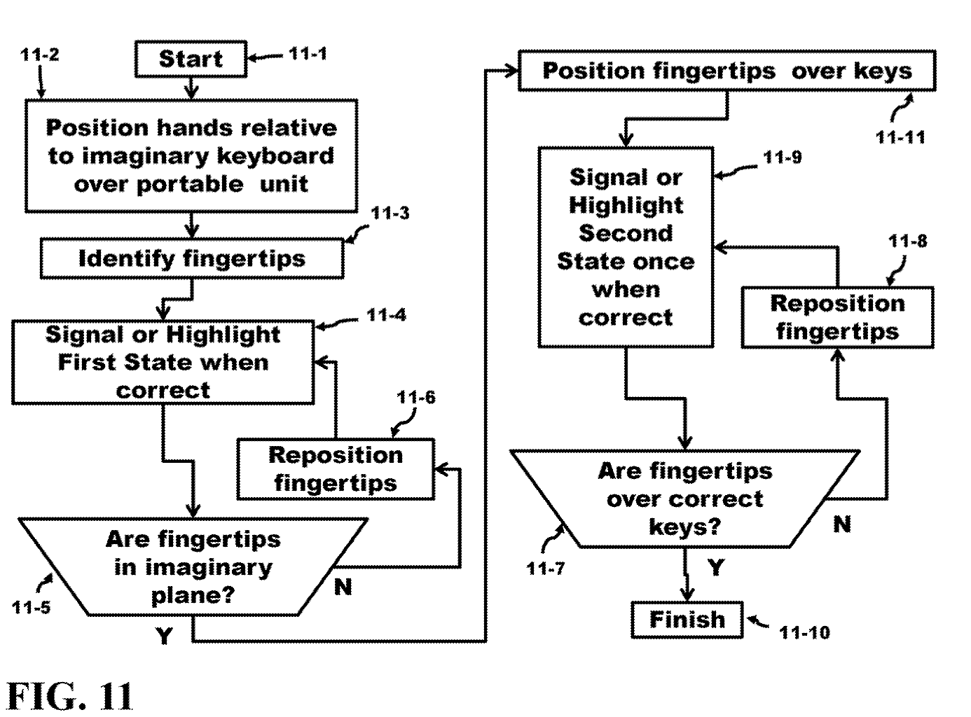

FIG. 11 illustrates another flowchart which positions hands relative to the initialization plane of a virtual keyboard 11-2 and identifies the fingertips 11-3 until all the fingertips are in the initialization plane. Signal or highlight a first state when the fingertips are placed over the appropriate keys 11-4. Or until the fingered tips are verified as being over the correct keys 11-5. First, we start 11-1 and move to position the hands in the initialization plane of a virtual keyboard plane over the portable unit 11-2. At this point, the fingertips are identified 11-3 relative to the initialization plane of a virtual keyboard. When the finger tips are identified then signal or highlight the keys in some first state when correct 11-4. This first state can be a particular color particular shade given to the key which you should currently show on a display screen. If all the fingertips in imaginary plane are not on the virtual plane 11-5, then reposition the fingertips 11-6 and wait until the first state occurs 11-14. After all the fingertips are in the initialization plane of a virtual keyboard, the next step is to position the fingertips over the appropriate keys 11-11. Once the fingertips are over the appropriate key emit an audio signal or highlight a second state when correct 11-9. The second state would be either a different audio sound or different color being emitted from the keys on the display screen of the smart phone. If all the fingertips are over the correct keys 11-7. then the user is finished 11-10. Otherwise, reposition the fingertips 11-8 and repeat until the second state signal 11-9 is correct. Then, confirm that the fingertips are over the correct keys 11-7 and moved to finish 11-10.

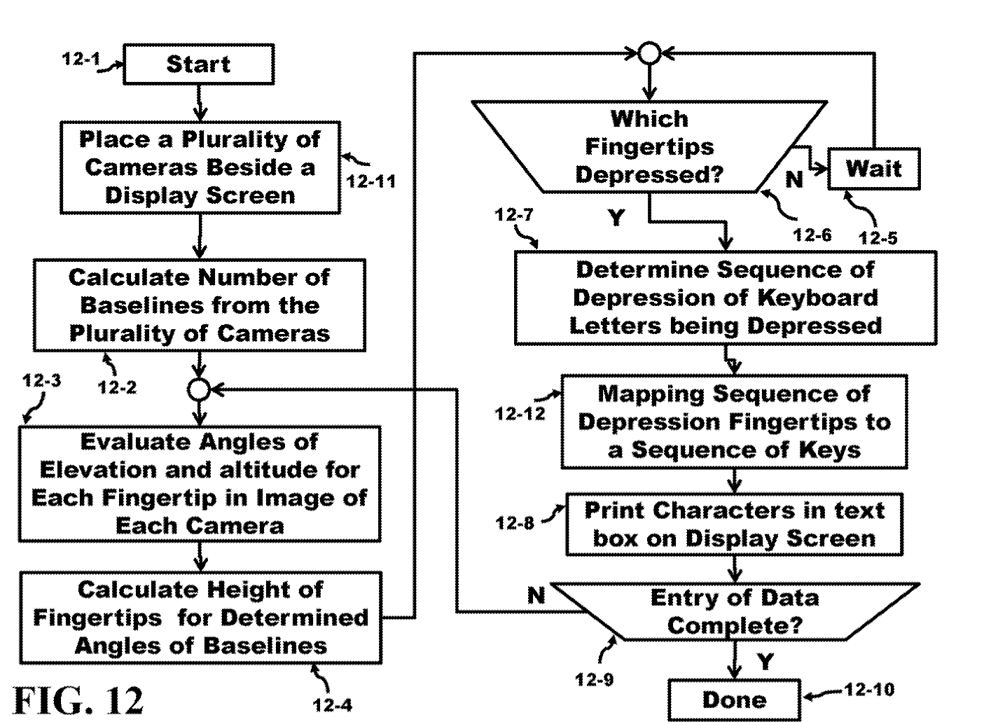

The flowchart in FIG. 12 places a plurality of cameras beside a display screen, calculates the number of baselines dependent on the plurality of cameras that exist on the front surface of the smart phone. The system calculates the angle of elevation and altitude from each of the camera images for each finger. The system determines when the finger is depressed. The system can identify those particular fingertips and print the characters corresponding to the locations of the fingertips on the display screen in the sequence that the fingertips are enter the activation plane producing the corresponding sequence of keys. There are two important issues to providing an accurate data for the keyboard. The first is the detection of the fingertips in the activation plane and the second is the sequence in which the fingertips are detected in the activation plane which translates into a textual sequence of keys or characters that create words, sentences, and paragraphs into a database entry system.

First we start at 12-1, place a plurality of cameras beside the display screen of the wireless portable unit 12-11 and calculate the number of baselines from the number of cameras 12-2. Once all the baselines are known, evaluate the angle of elevation and altitude for each and every fingertip in the obtained image of each camera along that baseline 12-3. Next, calculate the height of these fingertips for the determined angles of all the baselines 12-4. Determine which fingertips are depressed 12-5 and wait 12-6 until all the calculations are complete. Determine the sequence that the keyboard letters are depressed 12-7. Mapping the sequence of depressed fingertips to a sequence of Keys (Characters) 12-12. Knowing the sequence, these characters can be displayed in a text box of the display screen 12-8. If all the entry of data is complete or typing is finished 12-9 moved to done 12-10. Otherwise, return to calculate angles and altitude for each finger 12-3 and repeat the process flow.

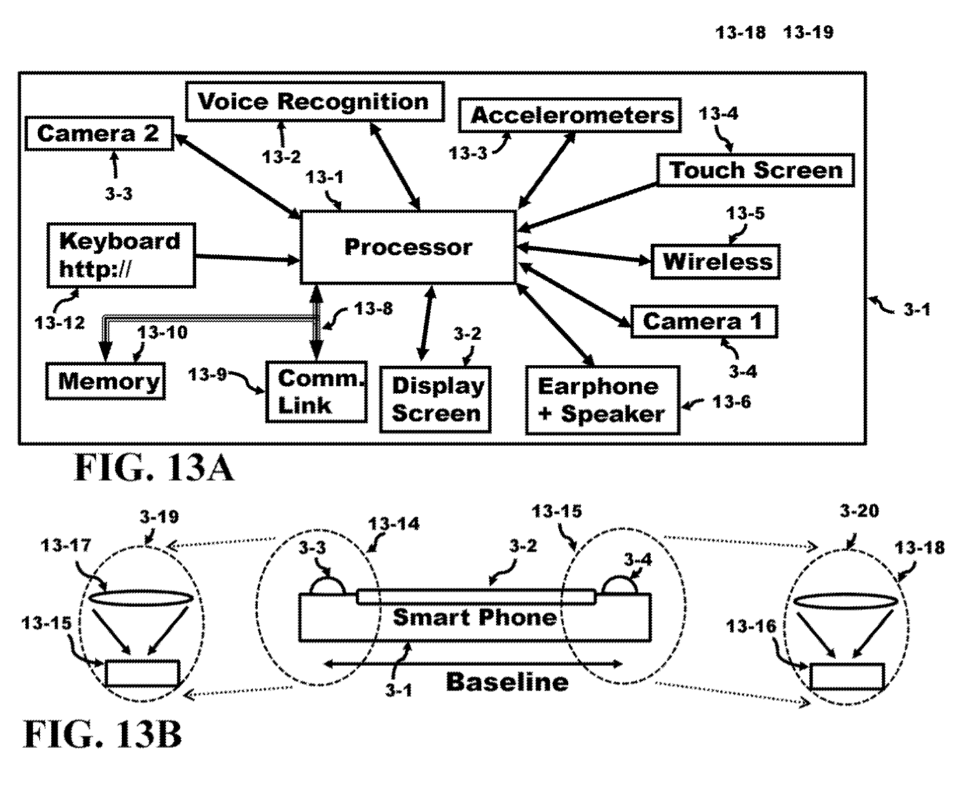

FIG. 13A illustrates the block diagram of the smart phone 3-1 comprising some components, both internal or external, that perform the function of determining the position of the fingertips based on the angle of the rays emitting from all the baselines. The processor 13-1 couples to all of the major components presented within the smart phone. A voice recognition 13-2 can detect spoken words or Internet spoken words. An accelerometer 13-3 can be used by the smart phone to determine movement. A touchscreen 13-4 can be used to enter data into the smart phone. A wireless block 13-5 interfaces the smart phone 3-1 to the external world by a communication network. A first camera 3-4 is coupled to the processor, and earphone and speaker 13-6 can be used to listen privately or listen in a conference mode. A display screen 3-2 fills a large portion of one side of the smart phone and this particular portion is where the physical keypad is presented to the user via the touchscreen 13-4. A bus 13-8 interfaces the processor 13-1 to memory 13-10. It also interfaces to a communication link 13-9 which can be a secondary way in and out of the chip to the communication network. The memory 13-10 can be subdivided into different memories and or located off chip through the communication link 13-9. The keyboard 13-12 is what would display on the display screen 3-2 and is typically a very small keyboard making it difficult to enter in data using fingertips. This process is prone to error and at times the user has to backtrack and reenter the appropriate character. Features that allow correction as in anticipation of the proper spelling of words help to minimize the backtracking, but backtracking still occurs. Then the second camera 3-3 is showing coupled to the processor. The first camera 3-4 and the second camera 3-3 are at the periphery of one side of the smart phone, preferably on opposite sides of the display screen 3-2. The distance between the first camera 3-4 and a second camera 3-3 is the baseline and additional cameras can be coupled to the processor and placed such that they surround the display screen 3-2 for added baseline enhancement. As the camera count increases, the accuracy of determining the positioning of the fingertips also increases. These cameras can be replaced by plenoptic cameras for improved accuracy of fingertip position.

FIG. 13B illustrates the smart phone 3-1 with a display screen 3-2 and two cameras 3-3 and 3-4 on the same side surrounding the display screen 3-2. Within the smart phone, the regions 13-14 and 13-15 are further illustrated by 13-19 and 13-20, respectively. The blowup of 13-14 comprising the camera 3-3 is shown as 3-19, where the camera lens 13-17 is projecting light onto a detector 13-15. The blowup of 13-15 comprising the camera 3-4 is shown as 3-20, where the camera lens 13-18 is projecting light onto a detector 13-16. For each camera, there is a separate camera lens and a separate detector. If a plenoptic camera is used there is an array of microlenses and one or more detectors. The detector can be an integrated circuit chip fabricated in the CMOS technology or in the CCD technology. These detectors are integrated circuits that can translate photons into electrical signals. These electrical signals are translated into digital signals then fed through an interconnect on the smart phone 3-1 and applied to the processor 13-1 for further numerical manipulation of the digital bits comprising the digital signals. This numerical calculation is used to determine the positioning of the fingertips being either in the initialization plane of a virtual keyboard or in the activation plane. As more cameras are added, additional camera lenses and detectors are added. All of the cameras based on their distance from one another on the smart phone determine the various baselines. These cameras provide reference data which the processor uses to determine a more accurate fingertip placement. This placement is feed to the display screen to highlight the particular keys affected. When the processor determines that the fingertips are in the activation layer, the particular keys in the display screen may have a new color or shading applied to them to indicate that these particular keys were activated or depressed. These cameras can be replaced by plenoptic cameras for improved accuracy of fingertip position.

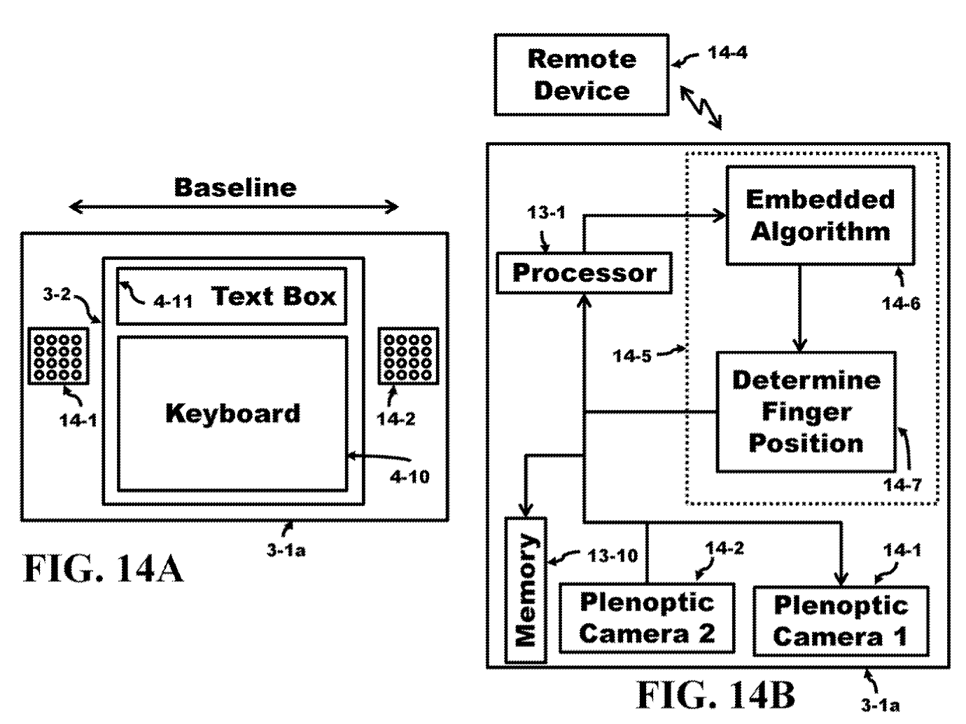

FIG. 14A illustrates a smart phone 3-1a. The smart phone contains two plenoptic cameras 14-1 and 14-2 on the side of the display screen 3-2. Both are a 4×4 array of individual cameras, but could be any sized array, with microlenses which takes the image simultaneously. The processor 13-1 combines the obtained images of each plenoptic camera together. The display screen 3-2 can display the plenoptic image captured by both plenoptic camera lenses 14-1 and 14-2. A stereoscopic image created by the plenoptic cameras which may be superimposed over an image of the FOV to display an image due to the outputs from both plenoptic cameras. The baseline separation of the plenoptic cameras help to improve the long rage (LR) stereoscopic 3-D image that can be focused to different planes of depth (PODs). The LR stereoscopic 3-D image improves as the baseline increases. The fingertips are detected by the plenoptic cameras 14-1 and 14-2 and applied to the embedded algorithm 14-6 to determine the height of the fingertips. The displayed keyboard 4-10 displays the keys and the fingertips are in the virtual keyboard plane. The activated text is displayed in the textbox 4-11.

A plenoptic camera can be used in place of the regular camera described earlier to determine the location of the fingertips. The plenoptic camera offers an improvement in detecting the fingertips position since each plenoptic camera comprises an array of microlens where each microlens can capture an image. The number of cameras in a plenoptic camera system effectively increases by the array size used in the plenoptic camera. The array size cab be 4×4, 6×6, etc. providing 16, 36 cameras per camera locations.

FIG. 14B illustrates a block diagram of the smart phone 3-1a comprising two plenoptic cameras 14-1 and 14-2. The smart phone 3-1a comprises a processor 13-1 coupled to an finger estimating system 14-5. The processor 13-1 is also coupled to a memory 13-10 and the plenoptic cameras 14-1 and 14-2. The finger estimating system 14-5 contains the embedded algorithm 14-6 to determine the finger position 14-7. The two cameras 14-1 and 14-2 providing a LR stereoscopic 3-D image that can be focused to different PODs. The remote device 14-4 can be the Internet, the intranet, the cloud, or any servers that can transfer data to/from the smart phone 3-1a. The communication link can be cellular, Wi-Fi, Bluetooth, wig be, or any other wireless standard that can transfer data between two locations.

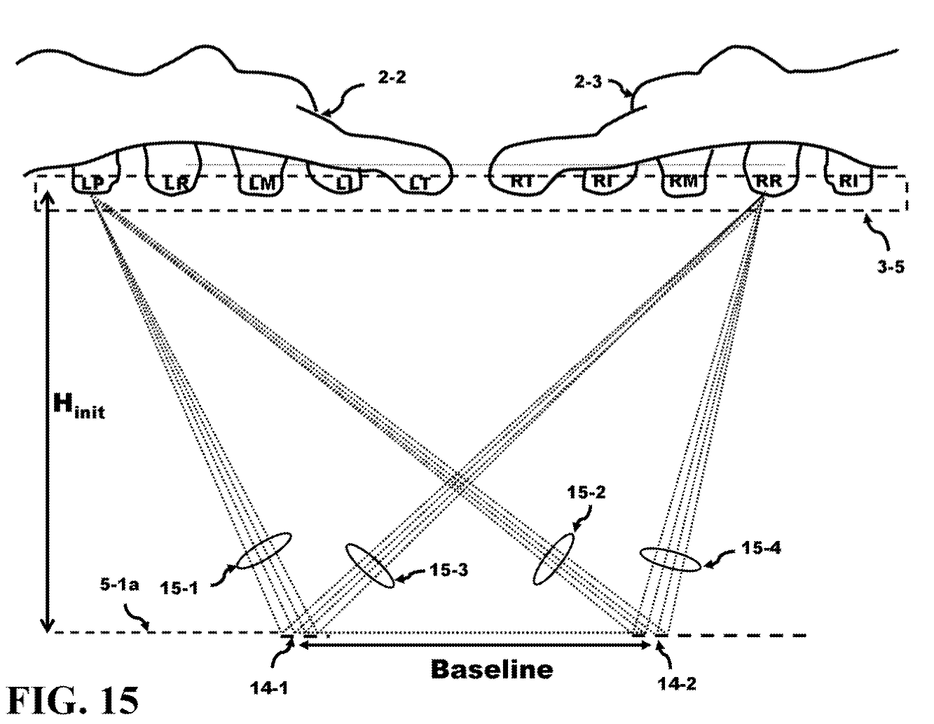

FIG. 15 illustrates the fingers in the initialization plane of a virtual keyboard 3-5. As these fingers are within the initiation plane of the virtual keyboard 3-5, the plenoptic cameras at 14-1 and 14-2 at the ends of the baseline can be used to measure the approximate angle of the left pinky, the left ring finger, the left middle finger, left index the left on the left hand 2-2. On the right-hand 2-3, the initialization plane of a virtual keyboard plane 3-5 can contain the right thumb, the right index finger, the right middle finger, the right ring finger, and the ring right index finger. All of these fingers are displaced from one another within the initialization plane of a virtual keyboard plane 3-5. Because of their displacement and the baseline distance between the two plenoptic cameras each of the plenoptic cameras intercepts different rays for the left pinky of the left-hand 2-2. In other words, the left plenoptic camera 14-1 has microlens array causing several rays 15-1 from the plenoptic camera 14-1 to intercept the left pinky (LP). The right plenoptic camera 14-2 has microlens array causing several rays 15-2 from the plenoptic camera 14-2 to intercept the left pinky. The left plenoptic camera 14-1 has microlens array causing several rays 15-3 from the plenoptic camera 14-1 to intercept the right ring finger (RR). The right plenoptic camera 14-2 has microlens array causing several rays 15-4 from the plenoptic camera 14-2 to intercept the right ring finger (RR). The finger estimating system in combination with the embedded algorithm are used to determine the plane of depth, and determine the approximate angle where the height based on the plane of the display screen 5-1a and the large baseline distance one can calculate the height Hᵢₙᵢₜ between the virtual keyboard plane 3-5 translated to lie co-planar with the physical keyboard plane 3-5 or the plane of the display screen to 5-1a. The remaining fingers have similar bundles of rays from the plenoptic cameras but are not illustrated for clarity. The angle of these rays from the plane of the display screen 5-1a for each of the plenoptic cameras has not been illustrated but can be determined by the finger estimating system in combination with the embedded algorithm to determine the plane of depth and the known height of the virtual keyboard plane 3-5.

Plenoptic cameras offer an ability to take a picture of a setting and refocus the image of the setting to different POD using the original Light Field Photograph (LFP) image. A plenoptic camera comprises of a microlenses array and at least one image sensor array. Each microlens captures all the light in its field of view (FOV) that arrives along the rays entering that particular microlens. The plenoptic camera offers an array of microlens measuring each fingertip. The accuracy of determining the finger position improves as the array size increases since there are a multiple of microlens providing data about the position of the fingertip. The microlenses array may be microlens placed in an array of 4×4, 6×6, 20×20, etc. Since each microlens is displaced from another in the array, each microlens captures all the light of a slightly different FOV or different viewpoint. Thus, the light striking one region of the microlenses array is different than the light striking another region of the microlenses array. Since the light information captured by the image sensor array due to a plurality of microlenses can be stored in memory, a computer algorithm can be developed to manipulate the light information retrieved from memory to generate how the image would appear when viewed from a different viewpoint. These different viewpoints can provide images having different POD while still using the original LFP image. The microlenses can be located between a main lens and the image sensor array. Several known software tools based on the computer algorithm, hereinafter called “embedded algorithm”, can be manipulated to alter the POD of the LFP image dynamically without the need to take another LFP image.

Finally, it is understood that the above description are only illustrative of the principles of the current invention. It is understood that the various embodiments of the invention, although different, are not mutually exclusive. In accordance with these principles, those skilled in the art may devise numerous modifications without departing from the spirit and scope of the invention. Although the portable aspect of the wireless system has been presented, the same techniques can be incorporated in non-portable systems therein. The camera could be a still image camera taking single pictures or a video camera taking multiple pictures per second proving the illusion of continuous motion when replaced to a user therewith. A camera is comprises a single main lens focused on an image sensor. A camera can be as simple as a pinhole and an image sensor. A plenoptic camera comprises of an array of microlenses is placed at the focal plane of the camera main lens. The image sensor is positioned slightly behind the microlenses. Thus, a plenoptic camera is a camera with an array of microlenses between the main lens and the image sensor. A plenoptic camera comprises of an array of microlenses is placed at the focal plane of the camera main lens. The image sensor is positioned slightly behind the microlenses. Thus, a plenoptic camera is a camera with an array of microlenses between the main lens and the image sensor. A plenoptic camera can be as simple as an array of microlenses and at least one image sensor. A smart phone is discussed and described in this speciation; however, the smart phone can imply any portable wireless system such as a tablet, smart phone, eyeglass, notebook, cameras, etc. that are portable and wireless coupled to a communication system. The processor comprises a CPU (Central Processing Unit), microprocessor, DSP, Network processor, video processor, a front end processor, multi-core processor, or a co-processor. All of the supporting elements to operate these processors (memory, disks, monitors, keyboards, etc) although not necessarily shown are known by those skilled in the art for the operation of the entire system. In addition, other communication techniques can be used to send the information between all links such as TDMA (Time Division Multiple Access), FDMA (Frequency Division Multiple Access), CDMA (Code Division Multiple Access), OFDM (Orthogonal Frequency Division Multiplexing ), UWB (Ultra Wide Band), WiFi, etc.

What is claimed is:

1. A keyboard apparatus comprising:
a plurality of cameras located on a same surface of a wireless potable unit as a display screen;
a displayed keyboard located on a screen of said display screen;
a virtual keyboard located parallel and above said displayed keyboard on said screen;
said virtual keyboard has dimensions proportionally larger than said displayed keyboard; and
a finger estimating system to identify locations of fingertips relative to said virtual keyboard using images obtained from said cameras.

2. The apparatus of claim 1, further comprising:
an initialization plane of said virtual keyboard having a first working distance: and
an activation plane of said virtual keyboard having a second working distance.

3. The apparatus of claim 2, further comprising:
an elevation angle and a tilt altitude angle determined from at least two camera images calculates said location of fingertips based on said finger estimating system to determine if said location of fingertips are in said initialization or said activation plane.

4. The apparatus of claim 1, further comprising:
a projection of said elevation angle and said azimuth angle of said location of fingertips onto said initialization or said activation plane determines points on an x-y Cartesian coordinate plane.

5. The apparatus of claim 4, further comprising:
a mapping system translating said points on said x-y Cartesian coordinate plane into corresponding keys of said virtual keyboard.

6. The apparatus of claim 5, further comprising:
keys highlighted on said displayed keyboard a first way if location of fingertips are in said initialization plane and keys highlighted on said displayed keyboard a different way if location of fingertips are in said activation plane.

7. The apparatus of claim 5, further comprising:
a text box in said screen of said display screen displaying a sequence of keys corresponding to a corresponding sequence of said fingertips entering said activation plane.

8. The apparatus of claim 1, further comprising:
an embedded algorithm to identify a Plane of depth (POD) of fingertips relative to said virtual keyboard using Light Field Photograph (LFP) images of said cameras, wherein
at least one camera has one or more lens.

9. A keyboard apparatus comprising:
a plurality of plenoptic cameras located on a same surface of a wireless potable unit as a display screen;
a displayed keyboard located on a screen of said display screen;
a virtual keyboard located parallel and above said displayed keyboard on said screen;
said virtual keyboard has dimensions proportionally larger than said displayed keyboard;
an embedded algorithm to identify a Plane of depth (POD) of location of fingertips relative to said virtual keyboard using a Light Field Photograph (LFP) image obtained from said cameras; and
a finger estimating system to identify said locations of fingertips in an x-y Cartesian coordinate plane.

10. The apparatus of claim 9, further comprising:
an initialization plane of said virtual keyboard having a first working distance: and
an activation plane of said virtual keyboard having a second working distance.

11. The apparatus of claim 10, further comprising:
said embedded algorithm determines if location of fingertips are located in said initialization or said activation plane.

12. The apparatus of claim 10, further comprising:
a projection of an elevation angle and an azimuth angle of said location of fingertips onto said initialization or said activation plane determines points on the x-y Cartesian coordinate plane.

13. The apparatus of claim 12, further comprising:
a mapping system translating said points on said x-y Cartesian coordinate plane into corresponding keys of said virtual keyboard.

14. The apparatus of claim 13, further comprising:
keys highlighted on said displayed keyboard a first way if location of fingertips are in said initialization plane and keys highlighted on said displayed keyboard a different way if location of fingertips are in said activation plane.

15. The apparatus of claim 13, further comprising:
a text box in said screen of said display screen displaying a sequence of keys corresponding to a corresponding sequence of said fingertips entering said activation plane.

16. A method of using a virtual keyboard comprising the steps of:
placing a plurality of cameras beside a display screen of a wireless portable unit;
calculating a number of baselines based on said plurality of cameras;
evaluating angles of elevation and altitude for each fingertip in an obtained image from each camera;
calculating a height of each fingertip from said display screen based on said angles using the finger estimation system;
determining a sequence of fingertips that are depressed;
mapping said sequence of fingertips to a sequence of keys; and
printing characters corresponding to said sequence of keys in a text box of said display screen.

17. The method of claim 16, further comprising the steps of:
projecting said elevation angle and said azimuth angle of fingertips onto an initialization or an activation plane to determine points on an x-y Cartesian coordinate plane.

18. The method of claim 16, wherein
said mapping sequence translates said points on said x-y Cartesian coordinate plane into corresponding keys of said virtual keyboard.

19. The method of claim 16, further comprising the steps of:
highlighting keys of said displayed keyboard based on if said location of fingertips are located in said initialization or said activation plane.

20. The method of claim 16, wherein
a text box in said screen of said display screen displaying a sequence of keys corresponding to a corresponding sequence of said fingertips entering said activation plane.
